(19) United States
(12) Patent Application Publication
(10) Pub. No.: US 2006/0125149 A1
(43) Pub. Date: Jun. 15, 2006

(54) Method for forming duct made of elastomer

(76) Inventors: Seiichiro Takada, Kobe-shi (JP); Naoki Omori, Amagasaki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/350,793

(22) Filed: Feb. 10, 2006

Related U.S. Application Data
(63) Continuation-in-part of application No. PCT/JP04/10599, filed on Jul. 26, 2004.

(30) Foreign Application Priority Data
Aug. 19, 2003 (JP) 295502/2003

(51) Int. Cl. B29C 45/00; B29C 45/43

(52) U.S. Cl. 264/328.2; 264/335; 425/467; 425/556

(57) ABSTRACT

[Objects] In a method for forming a duct used as, e.g., an air duct for an automobile engine, and provided with a corrugated section as an undercut part in a part of the longitudinal direction of the duct, an elastomeric duct is formed with ensuring easy removal of a duct molded by injection from a core die even when the duct is made of a resin poor in elasticity. [Means to Solve the Problems] A method for forming an elastomeric duct having a corrugated section in a longitudinal direction thereof as a part of the duct by injection molding, which comprises injecting an elastomer material into a cavity formed with a cavity die for forming an external surface of the duct, and a core die for forming an internal surface of the duct, wherein the core die is a splittable core die which is axially splittable into two parts, one is a core die A for forming a duct area at least containing the corrugated section, and the other is a core die B for forming a duct area free from the corrugated section, and removing the duct area containing the corrugated section from the core die A with expanding at least the corrugated section in the radius direction by air injection after opening the cavity die.

### TECHNICAL FIELD

The present invention relates to a method for forming or producing an elastomeric duct or a duct made of an elastomer such as a rubber or a thermoplastic elastomer, for example, a duct as an air duct (such as an air intake duct for an automobile engine) for supplying air from an air cleaner to an engine. In particular, the present invention relates to a duct comprising a corrugated section as an undercut part at a part of a longitudinal direction thereof.

### BACKGROUND ART

Heretofore, as the above-mentioned duct, a rubber duct has been used which is an injection-molded article from a vulcanized rubber material. However, such a rubber duct has some problems, that is, the rubber duct is heavier than a resin duct and it is impossible to recycle the rubber duct. In recent years, in order to solve these problems, an air duct which is an injection molded article formed from a thermoplastic elastomer, particularly a polyolefinic thermoplastic elastomer, is in practical use. This resin air duct is, for example, described in Patent Document 1 in detail.

Patent Document 1: Japanese Patent Application Laid-Open No. 227012/1999 (JP-11-227012A)

The air duct obtainable by injection molding the thermoplastic elastomer is, in many cases, two- or three-dimensionally bended to a given direction. After injection molding, the air duct is pulled out from a die by so-called forcible ejection, that is, the air duct is removed from a core die with expanding the corrugated section by injecting air between the core die and the injection-molded article. However, since the resin duct is considerably inferior in elasticity relative to the rubber duct, there is also a problem that the resin duct cannot be smoothly removed from the core die depending on the position or number of a designed corrugated section. Further, forcible removal of the duct from the core die confronts a new problem damaging a product, resulting in deteriorating the quality of the product.

### DISCLOSURE OF THE INVENTION

### Problems to be Solved by the Invention

It is an object of the present invention to provide a method for forming or producing an elastomeric duct (or an elastomer duct), which ensures easy removal of a duct molded by injection from a core die even when the duct is made of a resin poor in elasticity. The present invention is achieved not by removing the duct from the core die at once but by conducting removal of the duct (including forcible ejection) in an appropriate and sequence (or stepwise) manner in accordance with a molding position of a corrugated section to be disposed in the duct, e.g., the molding position being the middle or the end in the longitudinal direction of the duct.

### Means to Solve the Problems

In order to achieve the above-mentioned objects, the present invention includes a method for forming a duct made of an elastomer (an elastomeric duct) having a corrugated section or area in a longitudinal direction thereof as a part of the duct by injection-molding, which comprises

injecting an elastomer material (elastomeric material) into a cavity formed with a cavity die for forming an external surface of the duct, and a core die for forming an internal surface of the duct, wherein the core die comprises a splittable core die which is axially splittable into two parts, one is a core die A for forming a duct area at least containing the corrugated section, and the other is a core die B for forming a duct area free from the corrugated section, and

removing the duct area containing the corrugated section from the core die A with expanding at least the corrugated section in a diametrical or radius direction by air injection after opening the cavity die.

Moreover, the invention includes a method for forming a duct made of an elastomer (or elastomeric duct) having a corrugated section or area in a longitudinal direction thereof as a part of the duct by injection-molding, which comprises injecting an elastomer material or elastomeric material into a cavity formed with a cavity die for forming an external surface of the duct, and a core die for forming an internal surface of the duct,

wherein the splittable core die comprises a shorter core die (such as the above-mentioned core die B) for forming a non-corrugated section of one end of the duct, and a longer core die (such as the above-mentioned core die A) for forming a remainder area of the duct containing the corrugated section, and the method comprises

a first die-removing step for pulling out the shorter core die after opening the cavity die to remove the non-corrugated section, and

a second die-removing step for pulling out the remainder area of the duct containing the corrugated section from the longer core die with expanding the corrugated section or area in the diametrical or radius direction to remove the remainder area of the duct.

In the second die-removing step, an ejection jig having an air inlet may be inserted into the inside of the end of the duct from which the shorter core die has been pulled out, air may be blown out from the air inlet to enter between the longer core die and the duct, and the corrugated section may be expanded in a radius direction, thereby the undercut state may be released to pull out the duct together with the ejection jig from the longer core die.

Further, the invention includes a method for forming a duct made of an elastomer (or elastomeric duct) having a corrugated section or area in a longitudinal direction thereof as a part of the duct by injection-molding, which comprises injecting an elastomer material or elastomeric material into a cavity formed with a cavity die for forming an external surface of the duct, and a core die for forming an internal surface of the duct,

wherein the splittable core die comprises a first core die (such as the above-mentioned core die A) for forming the duct area containing the corrugated section, and a second core die (such as the above-mentioned core die B) for forming the remainder area of the duct free from the corrugated section, and the method comprises

a first die-removing step for pulling out the first core die with expanding the corrugated section in the diametrical or radius direction after opening the cavity die to remove the duct area containing the corrugated section, and

a second die-removing step for pulling out the remainder area from the second core die to remove the remainder area free from the corrugated section.

In the first die-removing step, air may be injected to an air ventilation channel of the first core die, and blown out from an abutting surface between the first core die and the second core die to enter between the first core die and the duct, thereby the corrugated section may be expanded in the radius direction with releasing the undercut state for removing the first core die.

Incidentally, the invention includes a method for forming a duct made of an elastomer, wherein, in the second die-removing step of the above-mentioned invention, the remainder area of the duct free from the corrugated section is pulled out from the second core die with expanding the remainder area in the diametrical or radius direction to remove the remainder area.

In the second die-removing step, an ejection jig having an air inlet may be inserted into (or attached to) the inside of a part of one end of the duct from which the first core die has been already pulled out, air may be blown out from the air inlet to the inside so as to enter between the second core die and the remainder area of the duct, and the duct may be pulled out together with the ejection jig from the second core die while expanding the remainder area in the radius direction. The elastomer may comprise a thermoplastic elastomer.

The present invention further includes a method for forming a duct made of an elastomer (e.g., a thermoplastic elastomer) having a plurality of corrugated sections in a longitudinal direction thereof as a part of the duct by injection-molding, which comprises

injecting an elastomer material into a cavity formed with a cavity die for forming an external surface of a duct, and a core die for forming an internal surface of the duct, wherein the core die is a splittable core die which is axially splittable into two parts, one is a core die (i) for forming a duct area containing a first corrugated section, and the other is a core die (ii) for forming the remainder area containing the second corrugated section,

a first die-removing step for removing the duct area containing the first corrugated section by pulling out the splittable core die (i) with expanding the first corrugated section in the radius direction after opening the cavity die, and

a second die-removing step for removing the remainder area containing the second corrugated section by pulling out the remainder area from the splittable core die (ii) with expanding the remainder area in the radius direction.

Furthermore, the present invention includes a die unit for forming a duct made of an elastomer (e.g., a thermoplastic elastomer) having a corrugated section in a longitudinal direction thereof as a part of the duct by injection-molding. The die unit comprises a cavity die for forming an external surface of the duct, a core die for forming an internal surface of the duct, and an ejection zig or attachment. The core die is a splittable core die which is axially splittable into two parts, one is a core die A for forming a duct area at least containing the corrugated section, and the other is a core die B for forming a duct area free from the corrugated section. The ejection zig or attachment is inserted into the inside of one end of the duct, for removing the duct area containing the corrugated section from the core die A with expanding at least the corrugated section in the radius direction by air injection. Moreover, the ejection zig or attachment may have an air inlet for ejecting air to enter between the core die and the duct and expanding the corrugated section of the duct.

### Effects of the Invention

The method for forming a duct made of an elastomer according to the present invention, although using as a material a thermoplastic elastomer which is generally poor in elasticity compared with a vulcanized rubber, is suitable for a resin duct having a corrugated area as an undercut in a part of a longitudinal direction thereof and having a bended shape to a given direction. The method of the present invention ensures easy removal of an injection molded duct from a core die (including forcible ejection) not by removing the product from a core die at once with the use of forcible ejection but by conducting removal of the product gradually or stepwise in accordance with a shape or configuration of the product, particularly a molding position of a corrugated section formed [to be disposed] in the product, and resulting in escaping the damage of the product accompanied by removal of the product from the core die.

### BRIEF DESCRIPTION OF DRAWINGS

FIG. 1 is a sectional side elevation view of a duct formed by the present invention.

FIG. 2 is a sectional view of a die for injection molding for forming the duct of FIG. 1.

FIG. 3 is a sectional view for illustrating a first die-removing step in the duct of FIG. 1.

FIG. 4 is a sectional view for illustrating a second die-removing step in the duct of FIG. 1.

FIG. 5 is a sectional view for illustrating a second die-removing step in the duct of FIG. 1.

FIG. 6 is a sectional side elevation view of another duct formed by the present invention.

FIG. 7 is a sectional view of a die for injection molding for forming the duct of FIG. 6.

FIG. 8 is a sectional view for illustrating a first die-removing step in the duct of FIG. 6.

FIG. 9 is a sectional view for, illustrating a second die-removing step in the duct of FIG. 6.

FIG. 10 is a sectional view for illustrating a second die-removing step in the duct of FIG. 6.

FIG. 11 is a sectional side elevation view of another duct formed by the present invention.

### BEST MODE FOR CARRYING OUT THE INVENTION

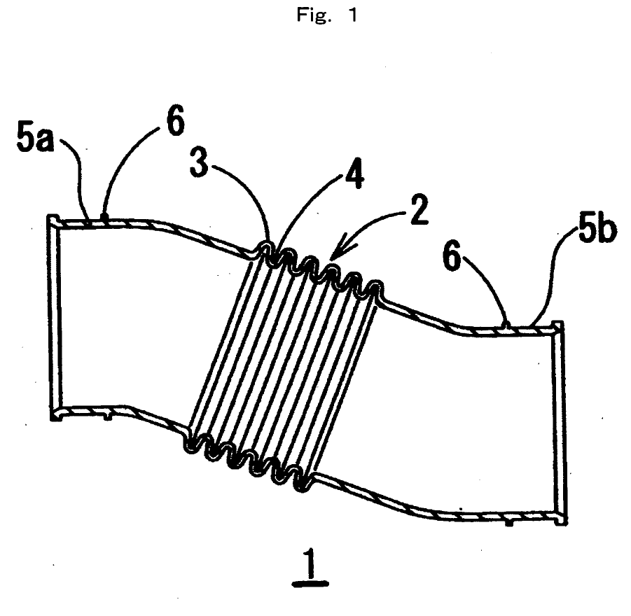

FIG. 1 is a sectional side elevation view of a resin duct 1 which is injection-molded into a shape bended to a given direction. The duct is used as an air duct for connecting an engine body of an automobile to an air cleaner (not shown), and has a corrugated section (or a corrugated part) 2 near the middle part which is a part of the duct in the longitudinal direction, and the corrugated section 2 is formed in which a plurality of convexities or peaks 3 having a large diameter and a plurality of concavities or valleys 4 having a small diameter are arranged alternately along with the axial center direction of the duct. Both ends 5a and 5b of the duct 1 are formed in non-corrugated sections whose surfaces are almost smooth, and are connected and fixed to an engine body or an air cleaner by clamps (not shown). Incidentally, symbols 6 and 6 show reinforcing ribs which are continuously and integrally formed along with the circumferential direction of the peripheral surface near the both ends 5a and 5b. The resin duct 1 is integrally formed by injection molding a thermoplastic elastomer (TPE) as a molding material. Among TPEs, a polyolefinic thermoplastic elastomer (TPO) is preferred, and one having a hardness (Hs (JISA: Japan Information Service Industry Association)) of 50 to 95 is preferably selected.

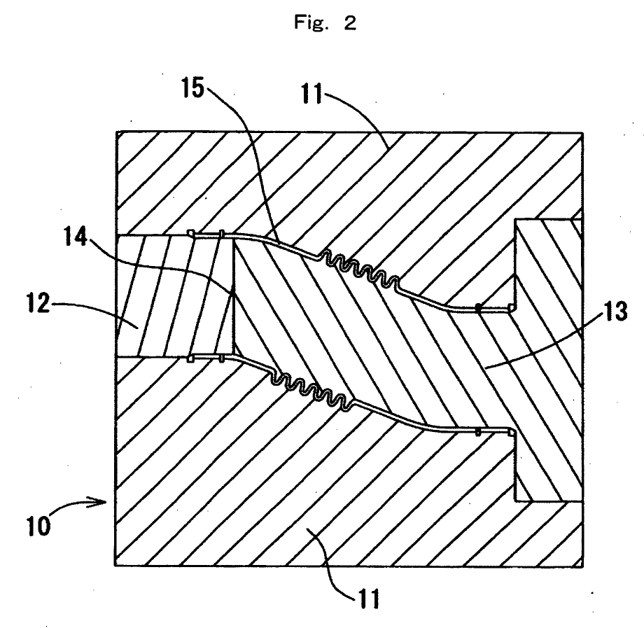

FIG. 2 shows a plan sectional view of a die 10 for injection molding in which the duct 1 is molded by injection. The die 10 comprises a pair of half cavity dies 11 and 11 on either side for forming an external shape of the duct, and splittable core die 12 and 13 for forming an internal shape of the duct, and TPE is injected to a cavity 15 of the die 10 to form a duct 1 having a corrugated section 2 as an undercut of FIG. 1. Incidentally, the cavity 15 precisely consists with product shape of the duct 1 as a final product.

The splittable core die is axially splittable into two parts, a core die A and a core die B. The splittable core die provides, as the core die B, a shorter core die 12 which is shorter in the axial direction, and, as the core die A, a longer core die 13 which is longer in the axial direction. The both dies 12 and 13 form a abutting (or contact) surface 14 to be faced or confronted with each other on adjacent end faces. The shorter core die 12 forms an internal shape of the end 5a being free from the corrugated section of the duct 1 and having an almost smooth surface. The longer core die 13 forms the remaining internal shape of the duct 1, containing the corrugated section 2 and the other end 5b.

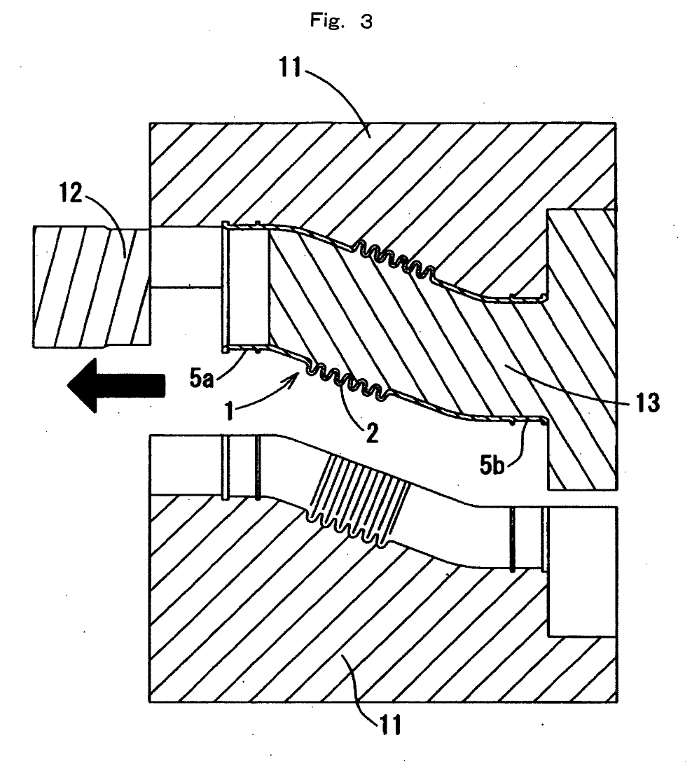

FIG. 3 illustrates the first die-removing step of the duct 1, in which after molding the duct 1 by injection, the shorter core die 12 is pulled out from the inside of the end 5a of the duct 1 in the direction of the arrow with opening one cavity die 11. On this occasion, the end 5a, being a duct area corresponding to the shorter core die 12, is extremely short in the overall length of the duct 1, and further does not have an undercut. Accordingly, the end 5a is easily removed from the core die.

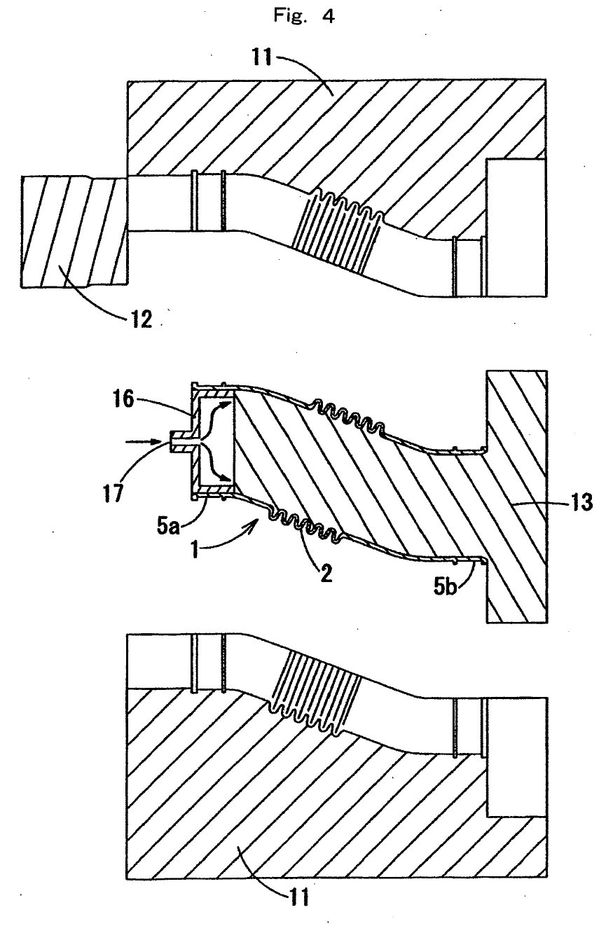

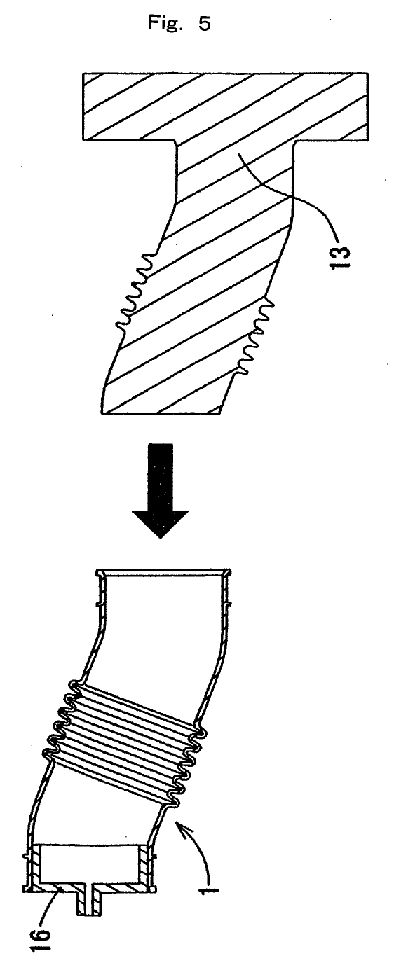

FIG. 4 illustrates the second die-removing step of the duct 1. After further opening the other cavity die 11, an ejection jig 16 having substantially short-cylindrical form is inserted into the inside of the end 5a of the duct from which the shorter core die 12 has been already pulled out. Air, preferably compressed air, is blown out from an air inlet 17 of the jig 16 to the inside of the jig 16 as indicated by the arrow. The air allows entering between the longer core die 13 and the duct 1, and the corrugated section 2 is expanded in a radius or diametrical direction depending on the elasticity of the material, and thereby the undercut state is released or cancelled. As shown in FIG. 5, the duct 1 is pulled out together with the ejection jig 16 from the longer core die 13. Then, the ejection jig 16 is pulled out to give a duct shown by FIG. 1.

Incidentally, in the above-mentioned embodiment, the cavity die may be a pair of half cavity dies opposed in the longitudinal direction or the perpendicular direction relative to the longitudinal direction, or the ejection jig may have any structure as long as the jig ensures air injection and integral pulling out from the core.

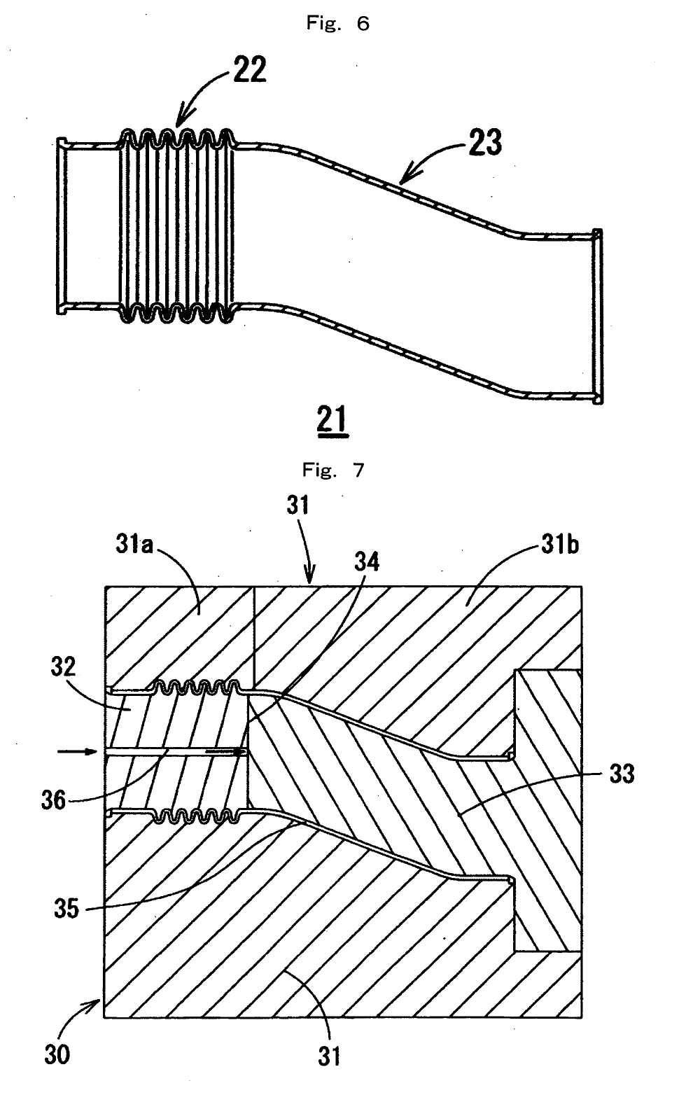

FIGS. 6 to 10 illustrate other embodiment of the present invention. As shown in FIG. 6, a resin duct to be molded by injection, that is, a resin duct 21 is different from the resin duct 1 of FIG. 1, because in the resin duct 21 a corrugated section 22 is formed close to one end thereof.

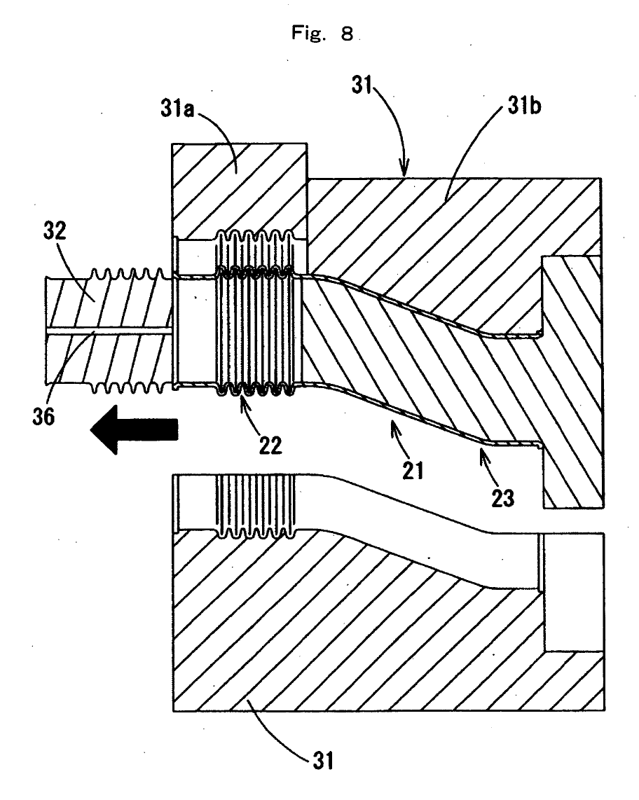

FIG. 7 shows a plan sectional view of a die 30 for injection molding in which the resin duct 21 is molded by injection. The die 30 comprises a pair of half cavity dies 31 and 31 on either sides (the longitudinal direction or the perpendicular direction relative to the longitudinal direction) for forming an external shape of the duct, and splittable core die 32, 33 for forming an internal shape of the duct, and TPE is injected to a cavity 35 of the die 30 to form a duct 21 having a corrugated section 22 as an undercut shown by FIG. 6. Moreover, one of the cavity dies 31 (which is located on the upper part in FIG. 7) is further axially splittable, and comprises a first part 31a for forming an external shape of the corrugated section 22, and a second part 31b for forming an external shape of the remainder area 23 other than the corrugated section 22. Incidentally, the cavity 35 precisely consists with a product shape of the resin duct 21 as a final product.

The splittable core die is axially split into two parts, one is the first core die 32 for forming an internal shape of one end of the corrugated section 22 as the core die A, and the other is the second core die 33 for forming an internal shape of the remainder area 23 other than the corrugated section 22 as the core die B. The both dies 32 and 33 form an abutting (or contact) surface 34 to confront with each other on adjunct end faces. The first core die 32 has an air ventilation channel 36 communicating or extending from the rear edge to the abutting surface 34.

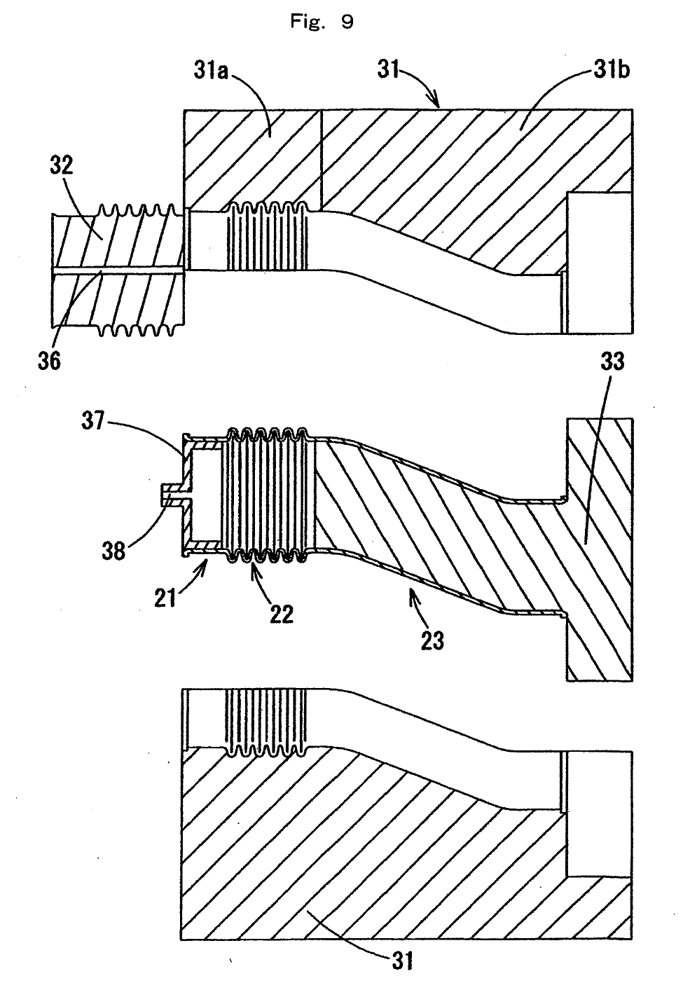

FIG. 8 shows the first die-removing step of the resin duct 21. After molding the resin duct 21 by injection, one cavity die 31 and the first member 31a of the other cavity die are slid in a perpendicular direction relative to the longitudinal direction to open the die, and in the state, the first core die 32 is pulled out from one end of the resin duct 21 in the axial direction of the arrow almost linearly by a cylinder or other means. On this occasion or operation, as shown in the arrow illustrated in FIG. 7, air is injected to the air ventilation channel 36 of the first core die 32, and blown out from the abutting surface 34 to enter between the first core die 32 and the duct 21, thereby the corrugated section 22 whose external surface is unsuppressed by the cavity die is expanded in the radius direction with releasing the undercut state for removing the first core die 32. Incidentally, in the first die-removing step, the external surface of the remainder area 23 of the duct is preferably held by the second member 31b of the cavity die 31. Thereby, forcible ejection of the first core die 32 is conducted with easy manner.

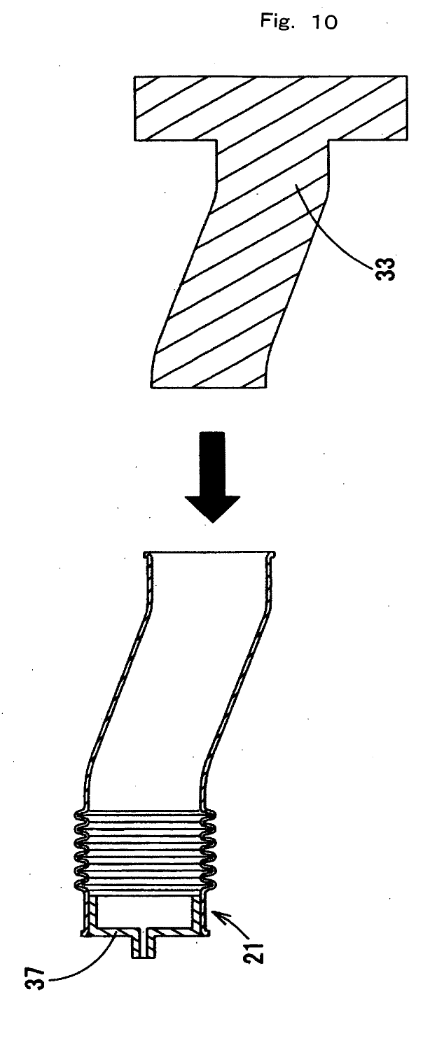

FIG. 9 shows the second die-removing step of the resin duct 21. After opening the die by further sliding the second part 31b of the other cavity die 31 in a perpendicular direction relative to the longitudinal direction, an cylindrical ejection jig 37 having an almost short-cylindrical configuration is inserted into (or attached to) the inside of a part of one end of the resin duct 21 from which the first core die 32 has been already pulled out. As it is, the remainder area 23 of the resin duct 21 is pulled out from the second core die 33. On the occasion or operation, preferably in the same manner as the above-mentioned first embodiment, air is blown out from the air inlet 38 of the ejection jig 37 to the inside so as to enter between the second core die 33 and the remainder area 23 of the resin duct 21, thereby the die can be removed while expanding the remainder area 23 in the radius direction. Then, as shown in FIG. 10, the resin duct 21 is pulled out together with the ejection jig 37 from the second core die 33. Thereafter, the ejection jig 37 is pulled out to give a resin duct 21 as shown in FIG. 6.

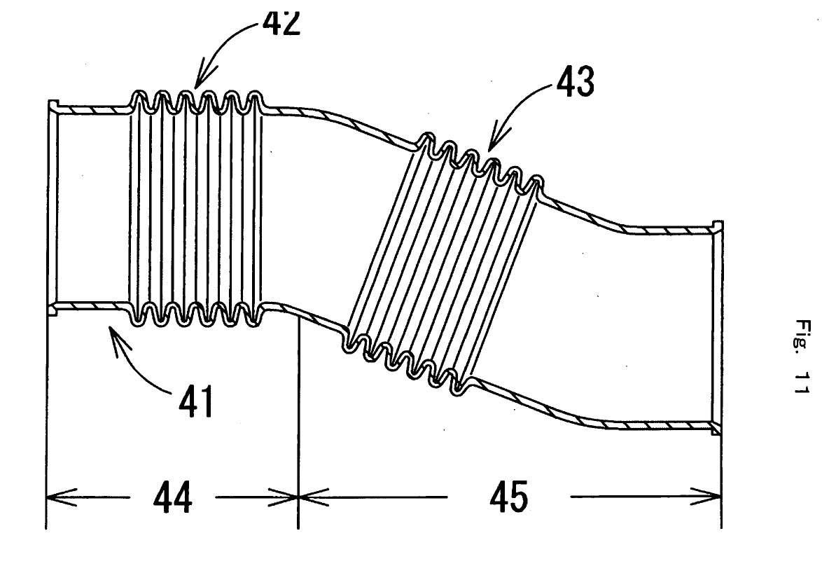

Incidentally, as shown in FIG. 11, a duct 41 having corrugated sections which forms a plurality of undercuts, a first corrugated section 42 and a second corrugated section 43, along the longitudinal direction, can be also formed by applying the present second embodiment. That is, the corrugated section 22 of the above-mentioned resin duct 21 corresponds to a duct area (or part or segment) containing the first corrugated section 42, and the remainder area 23 of the duct corresponds to a duct area containing the second corrugated section 43. In the first die-removing step, one of splittable core dies (not shown) is pulled out from a first die-removing area 44 containing the first corrugated section 42 for removing the die, and in the second die-removing step, a second die-removing area 45 containing the second corrugated section 43 is pulled out from the other divided core die (not shown) for removing the die.

The die unit of the present invention, for forming an elastomer duct having a corrugated section in a longitudinal direction thereof as a part of the duct by injection-molding, comprises a cavity die for forming an external surface of the duct, a core die for forming an internal surface of the duct, and an ejection zig or attachment. The core die is a splittable core die which is axially splittable into two parts, one is a core die A for forming a duct area at least containing the corrugated section, and the other is a core die B for forming a duct area free from the corrugated section. The ejection zig or attachment is inserted into the inside of one end of the duct, for removing the duct area containing the corrugated section from the core die A with expanding at least the corrugated section in the radius direction by air injection. Moreover, the ejection zig or attachment may have an air inlet for ejecting air to enter between the core die and the duct and expanding the corrugated section of the duct.

The duct may have a hollow and cylindrical configuration in the sectional view. The duct has open ends usually for connecting or attaching to an air cleaner and an engine body.

The removal operations are not limited to a specific manner so far as the elastomeric duct can be removed from the core die by expanding at least the corrugated section of the duct with use of gas blow (particularly air injection). As described above, the removal operations for removing the core die from the molded duct may be usually conducted in a sequence manner. For example, the non-corrugated section of the duct may be removed firstly by removing one of the splittable core die, and the corrugated section of the duct may be removed successively by removing the other of the splittable core die with expanding the duct. Alternatively, the corrugated section of the duct may be removed by removing one of the splittable die with expanding at least the corrugated section and the non-corrugated section of the duct may be removed by removing the other of the splittable die.

The core die may comprise at least a pair of splittable or separable dies. The splittable die may be splittable or separable each other in the axial direction. The splittable die has a die member for forming one end of the duct into which a jig or attachment can be attached or inserted. The core die may be extended from a base cylindrically and the base have a surface or wall contacting with the other end of the duct intimately for inhibiting a leakage of a blow gas in order to expand the duct effectively. The cavity die may comprise at least two cavity dies which are separable with each other in the perpendicular direction relative to the axial direction. Further, at least one of the cavity dies may comprise a plurality of die members (each arranged to the axial direction).

The jig or attachment for expanding the duct may have any structures or configurations as far as the duct is expandable with attaching or inserting the jig or attachment to one end of the molded duct.

The present invention can be applied to produce a hollow duct having any configurations such as straight or linear configuration, two- or three-dimensional configuration or shape. The present invention can be preferably applied to form a duct having a two- or three-dimensional configuration or shape since the removal of dies can be carried out in easy manner even if the corrugated section is positioned at any area of the duct. The corrugated section may be formed at any area of the duct such as straight area and/or bending area.

As the thermoplastic elastomer (TPE), there may be mentioned, for example, a polyamide-series elastomer, a polyester-series elastomer, a polyurethane-series elastomer (for example, a polyester-urethane elastomer, and a polyether-urethane elastomer), a polystyrenic elastomer, a polyolefinic elastomer (e.g., an elastomer comprising a polyethylene or polypropylene as a hard segment and an ethylene-propylene rubber or an ethylene-propylene-diene rubber as a soft segment; an olefinic elastomer comprising a hard segment and a soft segment which are different in crystallinity), a polyvinyl chloride-series elastomer, a fluorine-containing thermoplastic elastomer, and so on. These thermoplastic elastomers may be used singly or in combination.

Further, the duct may be comprise a rubber such as a diene-series rubber [e.g., a styrene-diene copolymerized rubber such as a styrene-butadiene rubber (SBR)], an olefinic rubber [e.g., an ethylene-propylene rubber (EPM), and an ethylene-propylene-diene rubber (EPDM)], an acrylic rubber, a fluorine-containing rubber, or a urethane-series rubber.

The rubber may be modified by incorporating an acid group (e.g., a carboxyl group, and an acid anhydride group).

### INDUSTRIAL APPLICABILITY

As apparent from the description mentioned above, in the method for forming an elastomeric duct (a duct made of an elastomer) according to the present invention, a duct having a corrugated section can be easily injection-molded by using a lightweight and recyclable resin material. Therefore, a resin air duct having excellent dimensional accuracy in internal and external surfaces can be obtained and adopted, for example, as an air intake member or part for an automobile engine, and the present invention is high in industrial applicability.

### Description of Reference Numerals

1 resin duct
2 corrugated section
3 peak
4 valley
5 both ends
6 reinforcing rib
10 die for injection molding
11 half cavity die
12 shorter core die
13 longer core die
14 abutting surface
15 cavity
16 ejection jig
17 air inlet
21 resin duct
22 corrugated section
30 die for injection molding
31 half cavity die
32 first core die
33 second core die
34 abutting surface
35 cavity
36 air ventilation channel
37 ejection jig
38 air inlet
41 duct
42 corrugated section
43 corrugated section
44 first die-removing area
45 second die-removing area

1. A method for forming a duct made of an elastomer having a corrugated section in a longitudinal direction thereof as a part of the duct by injection-molding, which comprises
injecting an elastomer material into a cavity formed with a cavity die for forming an external surface of the duct, and a core die for forming an internal surface of the duct, wherein the core die is a splittable core die which is axially splittable into two parts, one is a core die A for forming a duct area at least containing the corrugated section, and the other is a core die B for forming a duct area free from the corrugated section, and
removing the duct area containing the corrugated section from the core die A with expanding at least the corrugated section in the radius direction by air injection after opening the cavity die.

2. A method according to claim 1, wherein the splittable core die comprises a shorter core die for forming a non-corrugated section of one end of the duct, and a longer core die for forming a remainder area of the duct containing the corrugated section, and the method comprises
a first die-removing step for pulling out the shorter core die after opening the cavity die to remove the non-corrugated section, and
a second die-removing step for pulling out the remainder area of the duct containing the corrugated section from the longer core die with expanding the corrugated section in the radius direction to remove the remainder area of the duct.

3. A method according to claim 1, wherein the splittable core die comprises a first core die for forming the duct area containing the corrugated section, and a second core die for forming the remainder area of the duct free from the corrugated section, and the method comprises
a first die-removing step for pulling out the first core die with expanding the corrugated section in the radius direction after opening the cavity die to remove the duct area containing the corrugated section, and
a second die-removing step for pulling out the remainder area from the second core die to remove the remainder area free from the corrugated section.

4. A method according to claim 3, wherein in the second die-removing step, the remainder area free from the corrugated section is pulled out from the second core die with expanding the remainder area in the radius direction to remove the remainder area.

5. A method according to claim 2, wherein in the second die-removing step, an ejection jig having an air inlet is inserted into the inside of the end of the duct from which the shorter core die has been pulled out, air is blown out from the air inlet to enter between the longer core die and the duct, and the corrugated section is expanded in a radius direction, thereby the undercut state is released to pull out the duct together with the ejection jig from the longer core die.

6. A method according to claim 3, wherein in the first die-removing step, air is injected to an air ventilation channel of the first core die, and blown out from an abutting surface between the first core die and the second core die to enter between the first core die and the duct, thereby the corrugated section is expanded in the radius direction with releasing the undercut state for removing the first core die.

7. A method according to claim 3, wherein in the second die-removing step, an ejection jig having an air inlet is inserted into the inside of a part of one end of the duct from which the first core die has been already pulled out, air is blown out from the air inlet to the inside so as to enter between the second core die and the remainder area of the duct, and the duct is pulled out together with the ejection jig from the second core die while expanding the remainder area in the radius direction.

8. A method according to claim 1, wherein the elastomer comprises a thermoplastic elastomer.

9. A method for forming a duct made of an elastomer having a plurality of corrugated sections in a longitudinal direction thereof as apart of the duct by injection-molding, which comprises
injecting an elastomer material into a cavity formed with a cavity die for forming an external surface of a duct, and a core die for forming an internal surface of the duct, wherein the core die is a splittable core die which is axially splittable into two parts, one is a core die (i) for forming a duct area containing a first corrugated section, and the other is a core die (ii) for forming the remainder area containing the second corrugated section,
a first die-removing step for removing the duct area containing the first corrugated section by pulling out the splittable core die (i) with expanding the first corrugated section in the radius direction after opening the cavity die, and
a second die-removing step for removing the remainder area containing the second corrugated section by pulling out the remainder area from the splittable core die (ii) with expanding the remainder area in the radius direction.

10. A method according to claim 9, wherein the elastomer comprises a thermoplastic elastomer.

11. A die unit for forming a duct made of an elastomer having a corrugated section in a longitudinal direction thereof as a part of the duct by injection-molding, which comprises
a cavity die for forming an external surface of the duct, and a core die for forming an internal surface of the duct, wherein the core die is a splittable core die which is axially splittable into two parts, one is a core die A for forming a duct area at least containing the corrugated section, and the other is a core die B for forming a duct area free from the corrugated section,
which further comprises an ejection zig or attachment, wherein the ejection zig or attachment is inserted into the inside of one end of the duct, for removing the duct area containing the corrugated section from the core die A with expanding at least the corrugated section in the radius direction by air injection.

12. A die unit according to claim 11, wherein the ejection zig or attachment has an air inlet for ejecting air to enter between the core die and the duct and expanding the corrugated section of the duct.

13. A die unit according to claim 11, wherein the elastomer comprises a thermoplastic elastomer.
